(19) United States
(12) Patent Application Publication
(10) Pub. No.: US 2009/0141906 A1
(43) Pub. Date: Jun. 4, 2009

(54) Communication Headset Processing Multiple Audio Inputs

(75) Inventor: David James Truesdell, Acton, MA (US)

Correspondence Address: MILLS & ONELLO LLP, ELEVEN BEACON STREET, SUITE 605, BOSTON, MA, 02108, US

(73) Assignee: DAVID CLARK COMPANY INCORPORATED, Worcester, MA (US)

(21) Appl. No.: 11/948,253

(22) Filed: Nov. 30, 2007

(51) Int. Cl. G10K 11/16

(52) U.S. Cl. 381/71.6

(57) ABSTRACT

A communication headset includes first and second domes. The first and second domes include the speaker assembly having a first speaker coil and a second speaker coil. One speaker coil is for receiving a first audio signal, and the second speaker coil is for receiving a second audio signal and an active noise cancellation signal. Each of the speaker coils co-acts with a magnetic field to cause a diaphragm to move responsive to the first and second audio signals and the active noise cancellation signal individually or simultaneously. When the first audio signal is detected, a controller disconnects the second audio signal from the first dome of the headset.

### BACKGROUND OF THE INVENTION

1. Field of the Invention

The invention relates generally to communication headsets, and relates in particular to communication headsets that provide primary and secondary audio signals.

2. Description of the Related Art

Communication headsets typically include a speaker assembly in one or both earpieces of a headset. The earpieces may include, for example, ear domes that surround an ear and are urged against a user's head, ear pads that contact and are urged against the outer helix of a user's ear, or earplugs that engage the inner helix or canal of a user's ear.

Communication headsets that provide active noise cancellation typically include a microphone assembly in one or both earpieces that converts ambient noise to electrical signals and provides those electrical signals to an electronic circuit in an effort to cancel the background signal from the environment. For example, U.S. Pat. No. 4,455,675 discloses a headset system that includes active noise cancellation in which signals received by a microphone are inverted and amplified, and are then electrically combined with a communication signal prior to being sent to the speaker. In certain situations, however, such systems may cancel a portion of the communication signal itself

Many aircraft pilots wear headsets to enable them to communicate via two-way radio with other aircraft and air-traffic controllers. Often pilots or other users of headsets need to use more than one signal source, for example, the aircraft and air-traffic controllers, a cell phone and/or a music player.

### SUMMARY OF THE INVENTION

The present invention is directed to a headset assembly that includes a first dome that includes a first speaker assembly. The headset further includes a second dome that includes a second speaker assembly. The headset further includes a controller which receives a first audio signal from a first audio source and a second audio signal from a second audio source. The controller includes a switch for disconnecting the second audio signal from the first dome when the first audio signal is detected.

In one embodiment, the first speaker assembly includes a first speaker coil for receiving the first audio signal and a second speaker coil for receiving the second audio signal and an active noise cancellation signal.

In another embodiment, the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

In another embodiment, when the first audio signal is detected, the active noise cancellation signal without the second audio signal is output to the second speaker coil.

In one embodiment, the second speaker assembly includes a first speaker coil for receiving the first audio signal and a second speaker coil for receiving the second audio signal and an active noise cancellation signal.

In another embodiment, the first speaker coil and the second speaker coil coact with a magnetic field to cause a diaphragm to move responsive to the first and second audio signals and the active noise cancellation signal individually or simultaneously to cancel noise and to provide the first audio signal and the second audio signal to the speakers.

In another embodiment, when the first audio signal is detected, the first audio signal is output to the first speaker coil and the second audio signal and the active noise cancellation signal are output to the second speaker coil.

In one embodiment, the controller is in a battery pack.

In one embodiment, the headset assembly further includes an active noise cancellation circuit for generating an active noise cancellation signal.

In one embodiment, the first and second domes further include a microphone for detecting the signal within the first and second domes.

In accordance with another aspect of the invention, the invention is directed to a method of providing a plurality of signals in a headset assembly. The method includes providing a first dome comprising a first speaker assembly, providing a second dome comprising a second speaker assembly, and controlling a first audio signal from a first audio source and a second audio signal from a second audio source by disconnecting the second audio signal from the first dome when the first audio signal is detected.

In one embodiment, the first speaker assembly includes a first speaker coil and a second speaker coil, the first speaker coil receiving the first audio signal and the second speaker coil receiving the second audio signal and an active noise cancellation signal.

In another embodiment, the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

In another embodiment, the method includes, when the first audio signal is detected, outputting the active noise cancellation signal without the second audio signal to the second speaker coil.

In one embodiment, the second speaker assembly includes a first speaker coil and a second speaker coil, the first speaker coil receiving the first audio signal and a second speaker coil receiving the second audio signal and an active noise cancellation signal.

In another embodiment, the first speaker coil and the second speaker coil coact with a magnetic field to cause a diaphragm to move responsive to the first and second audio signals and the active noise cancellation signal individually or simultaneously to cancel noise and to provide the first audio signal and the second audio signal to the speakers.

In another embodiment, when the first audio signal is detected, the first audio signal is output to the first speaker coil and the second audio signal and the active noise cancellation signal are output to the second speaker coil.

In accordance with another aspect of the invention, the invention is directed to a headset assembly. The headset assembly includes a first dome that includes a first speaker assembly that includes dual-coil speakers and a second dome that includes a second speaker assembly that includes dual-coil speakers. The headset assembly further includes a controller which receives a first audio signal from a first audio source and a second audio signal from a second audio source, the controller comprising a switch for disconnecting the second audio signal from the first dome when the first audio signal is detected.

In one embodiment, the first speaker assembly includes a first speaker coil for receiving the first audio signal and a second speaker coil for receiving the second audio signal and an active noise cancellation signal.

In another embodiment, the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

In another embodiment, when the first audio signal is detected, the active noise cancellation signal without the second audio signal is output to the second speaker coil.

In one embodiment, the second speaker assembly includes a first speaker coil for receiving the first audio signal and a second speaker coil for receiving the second audio signal and an active noise cancellation signal.

In another embodiment, the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

In another embodiment, when the first audio signal is detected, the first audio signal is output to the first speaker coil and the second audio signal and the active noise cancellation signal are output to the second speaker coil.

In accordance with another aspect of the invention, the invention is directed to a method of providing a plurality of signals in a headset assembly. The method includes providing a first dome that includes a first speaker assembly that includes dual-coil speakers and providing a second dome that includes a second speaker assembly that includes dual-coil speakers. The method further includes controlling a first audio signal from a first audio source and a second audio signal from a second audio source by disconnecting the second audio signal from the first dome when the first audio signal is detected.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a communication headset having a first dome and a second dome in accordance with an embodiment of the invention.

FIG. 2 is a schematic block diagram of the communication headset of FIG. 1 in accordance with an embodiment of the invention.

FIG.3 is a schematic diagram of a controller of FIG. 2 in accordance with an embodiment of the invention.

FIG. 4 is a schematic block diagram of first and second domes of the communication headset of FIG. 1 in accordance with an embodiment of the invention.

### DETAILED DESCRIPTION Of PREFERRED EMBODIMENTS OF THE INVENTION

Some embodiments of the present invention are directed to a headset using a speaker assembly having dual-coil speakers, such as those described in U.S. patent application Ser. No. 11/208,975, which is incorporated herein by reference in its entirety.

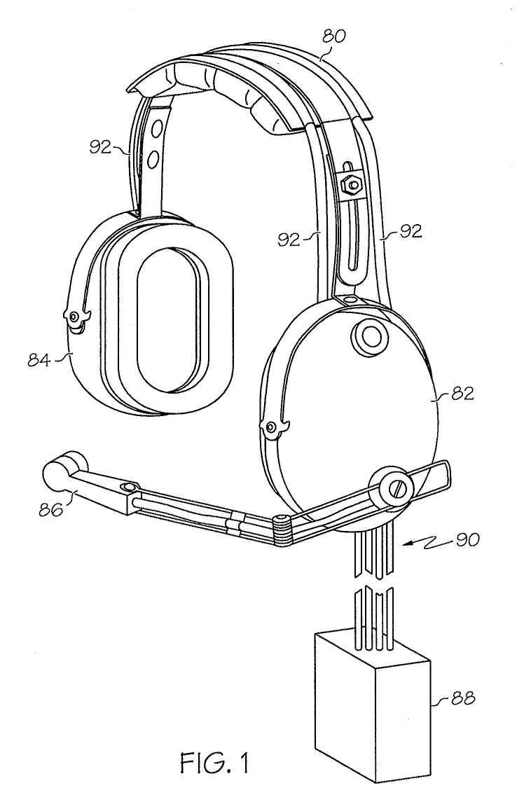

The speaker assembly having the dual-coil speakers can be used in a headset to permit a user to use more than one signal source, for example, the aircraft and air-traffic controllers, a cell phone and/or a music player. FIG. 1 is a schematic diagram of a communication headset 80 having a first dome 82 and a second dome 84 in accordance with an embodiment of the invention. The headset further includes a microphone 86 on the first dome 82. In another embodiment, the microphone is coupled to the second dome 84. A battery assembly 88, which includes a controller and a power source, is coupled to the headset 80 by wires 90 at the first dome 82. The battery may be a battery pack separate from the headset 80 (as shown), or, alternatively, could be in the headset 80. In an alternative embodiment, the wires 90 are coupled to the headset at the second dome 84. The wires 90 carry a primary signal and a secondary signal for each of the domes 82 and 84. Wires 92 are passed through the first dome 82 to the second dome 84 such that the wires are connected to the battery assembly 88 only on one side of the headset. The wires 92 include the primary signal and the secondary signal for the second dome 84.

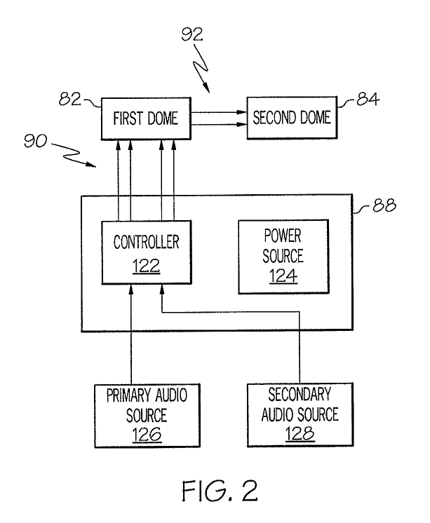

FIG. 2 is a schematic block diagram of the communication headset of FIG. 1 in accordance with an embodiment of the invention. A primary audio source 126 outputs a primary audio signal to a controller 122 in the battery assembly 88. The primary audio source can be, for example, an aircraft two-way radio. The battery assembly 88 includes a power source 124. The controller 122 is connected to the first dome 82 by wires 90 for providing a primary signal and a secondary signal for the first dome 82 and a primary signal and a secondary signal for the second dome 84. The controller 122 determines which signals are provided over wires 90. The first dome 82 is coupled to the second dome 84 by wires 92 for providing the primary signal and the secondary signal to the second dome 84. In one exemplary embodiment, the controller 122 controls which signals are output over wires 90 using single-sided switching.

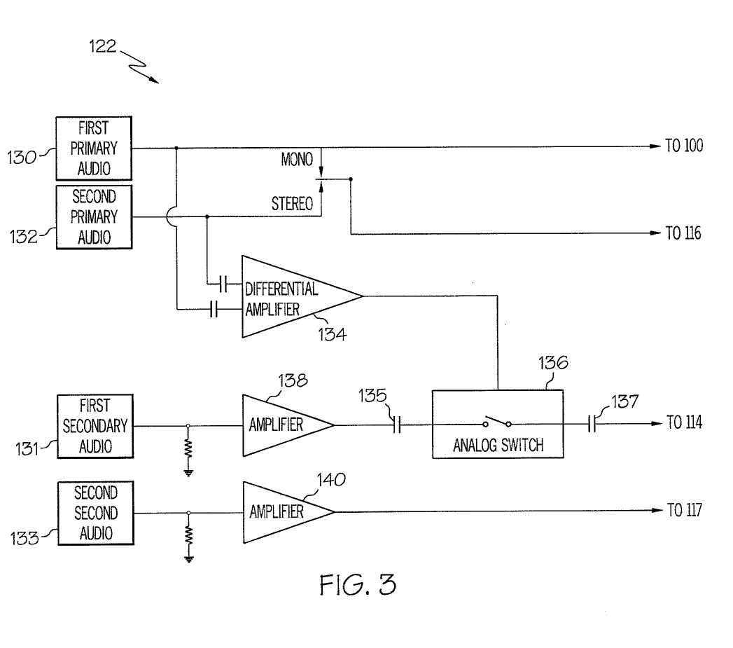

FIG. 3 is a schematic diagram of the controller 122 of FIG. 2 in accordance with an embodiment of the invention. In one exemplary embodiment, the controller 122 uses single-sided switching. The controller 122 receives a primary audio signal at a first input 130 and a second input 132 of the controller 122 from the primary audio source 126. The primary audio signal is output from the first input 130 of the controller 122 to a first input 100 of the first dome 82 and to a differential amplifier 134. The primary audio signal is output from the second input 132 of the controller 122 to a first input 116 of the second dome 84 and to the differential amplifier 134. The output of the differential amplifier 134 is output to an analog switch 136. The controller 122 receives a secondary audio signal at a third input 131 and a fourth input 133 of the controller 122 from the secondary audio source 128. The secondary audio is output from the third input 131 to an amplifier 138. The amplifier 138 outputs the amplified secondary audio signal to the analog switch 136. The analog switch 136 outputs the amplified secondary audio signal to a second input 114 of the first dome 82. If the primary audio signal is detected, then the analog switch 136 disconnects the amplified secondary audio signal such that the secondary audio signal is not applied to the first dome 82 when the primary audio signal is detected. The first dome 82 receives only the primary audio signal when the primary audio signal is detected. Capacitors 135 and 137 remove clicks when analog switch 136 operates. The secondary audio is output from the fourth input 133 to an amplifier 140. The amplified secondary audio signal is output to the second input 117 of the second dome 84. In an alternative embodiment, the analog switch 136 is coupled between the amplifier 140 and the second input 117 of the second dome 84 such that the secondary audio signal is not applied to the second dome 84 when the primary audio signal is detected.

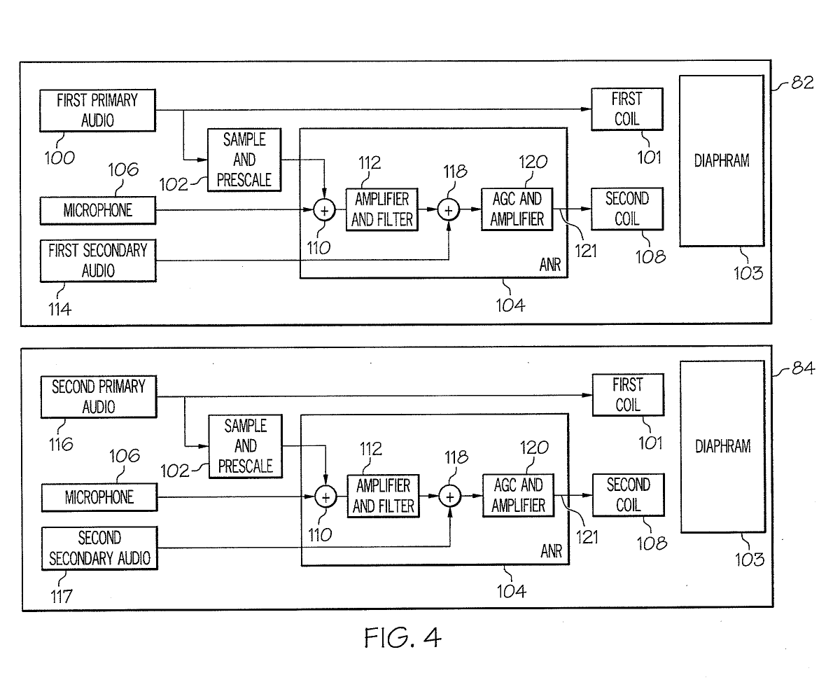

FIG. 4 is a schematic block diagram of the first and second domes 82 and 84 of the communications headset of FIG. 1 in accordance with an embodiment of the invention. The first and second domes 82 and 84 each have dual-coil speakers and receive a plurality of signals. The first and second speaker coils 101 and 108 coact to move the diaphragm 103 of the speaker such that the speaker outputs a signal that is a combination, e.g., summation, of the communication, e.g., primary audio, for example aircraft audio from a two-way radio, and a noise cancellation signal. The speaker coil that receives the noise cancellation signal also receives a secondary audio signal, for example, a cell phone signal or signal from a music player. In one embodiment, the first dome 82 is a left dome and the second dome 84 is a right dome. In another embodiment, the first dome 82 is a right dome and the second dome 84 is a left dome.

As illustrated in FIG. 4, the headset receives primary audio through the first input 100 of the first dome 82. The primary audio can be, for example, a signal from an aircraft two-way radio. The primary audio is applied to the first speaker coil 101. The primary audio is also sampled and prescaled at sampler 102. The output of sampler 102 is applied to active noise reduction (ANR) circuitry 104. The ANR circuitry 104 outputs an inverse noise signal, or active noise cancellation signal, in which the primary audio signal is processed, such that the primary audio signal applied to the first speaker coil 101 is not cancelled by a noise signal applied to a second speaker coil 108. A noise signal from a microphone inside the dome is received by the headset at a second input 106 and is applied to the ANR circuitry 104. A first summer 110 receives the noise signal from the microphone input 106 and the output of the sampler 102 in the ANR circuitry 104. The output of the first summer 110 is a summation of the primary audio and the noise from the microphone and is amplified and filtered at amplifier and filter 112 of the ANR circuitry 104. The output of the amplifier and filter 112 is applied to a second summer 118. Secondary audio is received at the second input 114 of the first dome 82. The secondary audio is a signal other than the aircraft audio from the two-way radio, for example, a cell phone signal or a music player such as an MP3 player. The secondary audio is output from the second input 114 of the first dome 82 to the second summer 118. The second summer 118 outputs a signal which is a summation of the noise signal and the secondary audio signal to an automatic gain controller (AGC) and amplifier 120. The AGC and amplifier 120 outputs a signal 121, which includes an inverse noise signal, or active noise cancellation signal, and the secondary audio signal from the ANR circuitry 104 to the second speaker coil 108. Each of the speaker coils 101 and 108 co-acts with a magnetic field to cause the diaphragm 103 to move responsive to the first audio signal, the second audio signal and the active noise cancellation signal individually or simultaneously.

The second dome 84 operates in the same fashion as the first dome 82. The second dome includes first input 116 and second input 117.

When a primary audio signal is detected, the first dome 82 receives only the primary audio signal, as illustrated in FIG. 3. The second dome 84 receives both the primary and secondary audio signals. When the primary audio signal is detected, the second input 114 of the first dome 82 does not receive the secondary audio signal, and the signal 121 applied to the second speaker coil 108 of the first dome 82 includes only the inverse noise signal. When the primary audio is detected, the first speaker coil 101 of the second dome 84 receives the primary audio signal and the second speaker coil 108 of the second dome 84 receives the signal 121 including the inverse noise signal and the secondary audio signal.

In an alternative embodiment, when a primary audio signal is detected, the second dome 84 receives only the primary audio signal and the first dome 82 receives both the primary and secondary audio signals. When the primary audio signal is detected, the second input 117 of the second dome 84 does not receive the secondary audio signal and the signal 121 applied to the second speaker coil 108 of the second dome 84 includes only the inverse noise signal. When the primary audio is detected, the first speaker coil 101 of the first dome 82 receives the primary audio signal and the second speaker coil 108 of the first dome 82 receives the signal 121 including the inverse noise signal and the secondary audio signal.

The headset in accordance with the invention facilitates the use of a plurality of signals. A pilot or other user of the headset can listen to music or cell phone and still be able to receive the communications from the two-way radio by receiving only the communications from the two-way radio in one dome of the headset and both the cell phone or music player and the communications from the two-way radio in the other dome of the headset.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A headset assembly, comprising:
a first dome comprising a first speaker assembly;
a second dome comprising a second speaker assembly; and
a controller which receives a first audio signal from a first audio source and a second audio signal from a second audio source, the controller comprising a switch for disconnecting the second audio signal from the first dome when the first audio signal is detected.

2. The headset assembly of claim 1, wherein the first speaker assembly includes a first speaker coil for receiving the first audio signal and a second speaker coil for receiving the second audio signal and an active noise cancellation signal.

3. The headset assembly of claim 2, wherein the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

4. The headset assembly of claim 2, wherein, when the first audio signal is detected, the active noise cancellation signal without the second audio signal is output to the second speaker coil.

5. The headset assembly of claim 1, wherein the second speaker assembly includes a first speaker coil for receiving the first audio signal and a second speaker coil for receiving the second audio signal and an active noise cancellation signal.

6. The headset assembly of claim 5, wherein the first speaker coil and the second speaker coil coact with a magnetic field to cause a diaphragm to move responsive to the first and second audio signals and the active noise cancellation signal individually or simultaneously to cancel noise and to provide the first audio signal and the second audio signal to the speakers.

7. The headset assembly of claim 5, wherein, when the first audio signal is detected, the first audio signal is output to the first speaker coil and the second audio signal and the active noise cancellation signal are output to the second speaker coil.

8. The headset assembly of claim 1, wherein the controller is in a battery pack.

9. The headset assembly of claim 1, further comprising an active noise cancellation circuit for generating an active noise cancellation signal.

10. The headset assembly of claim of claim 1, wherein the first and second domes further comprise a microphone for detecting the signal within the first and second domes.

11. A method of providing a plurality of signals in a headset assembly, comprising:
providing a first dome comprising a first speaker assembly;
providing a second dome comprising a second speaker assembly; and
controlling a first audio signal from a first audio source and a second audio signal from a second audio source by disconnecting the second audio signal from the first dome when the first audio signal is detected.

12. The method of claim 11, wherein the first speaker assembly includes a first speaker coil and a second speaker coil, the first speaker coil receiving the first audio signal and the second speaker coil receiving the second audio signal and an active noise cancellation signal.

13. The method of claim 12, wherein the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

14. The method of claim 12, further comprising, when the first audio signal is detected, outputting the active noise cancellation signal without the second audio signal to the second speaker coil.

15. The method of claim 11, wherein the second speaker assembly includes a first speaker coil and a second speaker coil, the first speaker coil receiving the first audio signal and a second speaker coil receiving the second audio signal and an active noise cancellation signal.

16. The method of 15, wherein the first speaker coil and the second speaker coil coact with a magnetic field to cause a diaphragm to move responsive to the first and second audio signals and the active noise cancellation signal individually or simultaneously to cancel noise and to provide the first audio signal and the second audio signal to the speakers.

17. The method of claim 15, wherein, when the first audio signal is detected, the first audio signal is output to the first speaker coil and the second audio signal and the active noise cancellation signal are output to the second speaker coil.

18. A headset assembly, comprising:
a first dome comprising a first speaker assembly comprising dual-coil speakers;
a second dome comprising a second speaker assembly comprising dual-coil speakers; and
a controller which receives a first audio signal from a first audio source and a second audio signal from a second audio source, the controller comprising a switch for disconnecting the second audio signal from the first dome when the first audio signal is detected.

19. The headset assembly of claim 18, wherein the first speaker assembly includes a first speaker coil for receiving the first audio signal and a second speaker coil for receiving the second audio signal and an active noise cancellation signal.

20. The headset assembly of claim 19, wherein the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

21. The headset assembly of claim 19, wherein, when the first audio signal is detected, the active noise cancellation signal without the second audio signal is output to the second speaker coil.

22. The headset assembly of claim 18, wherein the second speaker assembly includes a first speaker coil for receiving the first audio signal and a second speaker coil for receiving the second audio signal and an active noise cancellation signal.

23. The headset assembly of 22, wherein the first speaker coil and the second speaker coil coact with a magnetic field for causing a diaphragm to move responsive to the first and second audio signals and the active noise cancellation signal individually or simultaneously to cancel noise and to provide the first audio signal and the second audio signal to the speakers.

24. The headset assembly of claim 22, wherein, when the first audio signal is detected, the first audio signal is output to the first speaker coil and the second audio signal and the active noise cancellation signal are output to the second speaker coil.

25. A method of providing a plurality of signals in a headset assembly, comprising:
providing a first dome comprising a first speaker assembly comprising dual-coil speakers;
providing a second dome comprising a second speaker assembly comprising dual-coil speakers; and
controlling a first audio signal from a first audio source and a second audio signal from a second audio source by disconnecting the second audio signal from the first dome when the first audio signal is detected.
